(19) United States
(12) Patent Application Publication
(10) Pub. No.: US 2010/0047412 A1
(43) Pub. Date: Feb. 25, 2010

(54) Post Harvest Treatment of Fruit

(75) Inventor: Nigel Grech, Fresno, CA (US)

Correspondence Address: MARK D MILLER;KIMBLE, MACMICHAEL & UPTON, 5260 NORTH PALM AVENUE, SUITE 221, FRESNO, CA, 93704, US

(73) Assignee: PLANT PROTECTANTS, LLC, Visalia, CA (US)

(21) Appl. No.: 12/538,134

(22) Filed: Aug. 8, 2009

Related U.S. Application Data
(63) Continuation of application No. 61/090,320, filed on Aug. 20, 2008.

(51) Int. Cl. A23B 7/10; A23B 7/16

(52) U.S. Cl. 426/307; 426/321; 426/310

(57) ABSTRACT

Methods for protecting fruit, vegetables and ornamentals against post harvest microbial decay by applying systemic acquired resistance inducers such as phosphorous acid and/or one or more of the alkali metal salts of phosphorous acid in combination with Imazalil.

This application claims the benefit of U.S. Provisional application No. 61/090,320 filed on Aug. 20, 2008, which is incorporated herein by this reference in its entirety.

### BACKGROUND OF THE INVENTION

The present invention relates to protecting fruit, vegetables and ornamentals against attack by decay-causing organisms such as fungi. In particular, the present invention relates to methods of protecting fruit or vegetables or ornamentals against post harvest microbial spoilage by applying mixtures of systemic acquired resistance inducers in combination with Imazalil.

### FIELD OF THE INVENTION

It is a well-known practice in fruit and vegetable processing to apply anti microbial agents to the surface of freshly harvested fruit and vegetables for the purpose of controlling decay-causing organisms.

Systemic resistance inducers are known to elicit microbial resistance in plants but are not used in post harvest applications in fruit and vegetables because they do not provide control of microorganisms at an acceptable level.

Imazalil as mentioned herein is the generic name of the compound 1-[2-(2,4-dichlorophenyl)-2-(2-propenyloxy)ethyl]-1-imidazole.

With increasing regulatory and environmental pressure being applied on the post harvest fruit and vegetable sectors, many antimicrobial materials are being withdrawn or not reregistered. It is therefore desirable to provide methods of protecting fruit or vegetables or ornamentals against post harvest microbial spoilage using materials that are readily available, of low toxicity and not likely to be banned from registration.

The present invention provides novel methods of reducing microbial spoilage of fruit, vegetables and ornamentals utilizing materials that are of very low mammalian toxicity and are environmentally benign.

### SUMMARY OF THE INVENTION

The present invention includes methods for protecting fruit, vegetables and/or ornamentals against post harvest microbial decay by applying systemic acquired resistance inducers in combination with Imazalil. In some embodiments the materials applied to the fruit and/or vegetables include Imazalil as well as phosphorous acid and/or its alkali metal salts and/or ammoniacal salts. It has been determined that Imazalil alone helps protect fruits and vegetables from post harvest decay. It has also been determined that phosphorous acid and/or its salts alone also help protect fruits and vegetables from post harvest decay.

The effect of combinations of Imazalil with phosphorous acid (and/or its salts) in the reduction of post harvest spoilage was found to be greater than the sum of the individual effects of Imazalil alone or phosphorous acid (and/or its salts) alone in reducing post harvest spoilage at low or high temperatures.

### DETAILED DESCRIPTION

Embodiments of the present invention are further illustrated by the following non-limiting examples:

### EXAMPLE 1

In example 1, six different treatments (A-F below) were made. There were four replications for each of the six treatments, with each replicate comprising six fruit pieces. Thus, each treatment was applied to 24 fruit pieces. The fruit treated in this example were six freshly harvested, mature lemons. All treatments were conducted at 20° C. unless indicated differently.

Treatments were as follows:

A. Fruit immersed in water. Untreated uninoculated control.

B. Fruit immersed in water. Untreated inoculated control.

C. Fruit immersed in a solution containing a 200 ppm suspension of Imazalil for 2 minutes.

D. Fruit immersed in a solution containing 2% (w/w) potassium phosphite for 2 minutes.

E. Fruit immersed in a solution containing a mixture of 1 a 200 ppm suspension of Imazalil and 2% (w/w) potassium phosphite, for 2 minutes.

F. Fruit immersed in a solution containing a mixture of a 200 ppm suspension of Imazalil and 2% (w/w) potassium phosphite, for 2 minutes at 40° C.

After the treatments were applied and left to dry for 10 minutes, treatments B through F were inoculated with a mixed inocula of Green mold (P. digitatum) and Blue mold (P. italicum). Fruit inoculation was performed by piercing the fruit skin to a depth of 3-5 mm with a needle coated with spores from both fungi. Fruit was incubated at approximately 25° C. and decay development measured over 7 days from inoculation.

This experiment was repeated twice.

Results of Example 1:

TABLE 1
(Mean of two experiments)

| | | % change from |
|---|---|---|
| Treatment | Lesion diameter (mm) day 7 | inoculated control |
| A | 0 | — |
| B | 61 | — |
| C | 7 | −88 |
| D | 19 | −68 |
| E | 3 | −95 |
| F | 4 | −93 |

### EXAMPLE 2

In example 2, six different treatments (A-F below) were made. There were four replications for each of the six treatments, with each replicate comprising six fruit pieces. Thus, each treatment was applied to 24 fruit pieces. The fruit treated in this example were six freshly harvested, mature lemons. All treatments were conducted at 20° C. unless indicated differently.

Treatments were as follows:

A. Fruit immersed in water. Untreated uninoculated control.

B. Fruit immersed in water. Untreated inoculated control.

C. Fruit immersed in a solution containing a 200 ppm suspension of Imazalil for 2 minutes.

D. Fruit immersed in a solution containing 2% (w/w) potassium phosphite for 2 minutes.

E. Fruit immersed in a solution containing a mixture of 1 a 200 ppm suspension of Imazalil and 2% (w/w) potassium phosphite, for 2 minutes.

F. Fruit immersed in a solution containing a mixture of a 200 ppm suspension of Imazalil and 2% (w/w) potassium phosphite, for 2 minutes at 40° C.

After the treatments were applied and left to dry for 10 minutes, treatments B through F were inoculated with a mixed inocula of Green mold (P. digitatum) and Blue mold (P. italicum). Fruit inoculation was performed by piercing the fruit skin to a depth of 3-5 mm with a needle coated with spores from both fungi. Fruit was incubated at approximately 25° C. and decay development measured over 7 days from inoculation.

This experiment was repeated twice.

Results of Example 2:

TABLE 2
(Mean of two experiments)

| | Lesion diameter | % change from |
|---|---|---|
| Treatment | (mm) day 7 | inoculated control |
| A | 0 | — |
| B | 47 | — |
| C | 28 | −46 |
| D | 24 | −61 |
| E | 9 | −82 |
| F | 11 | −85 |

### EXAMPLE 3

In example 3, six different treatments (A-F below) were made. There were four replications for each of the six treatments, with each replicate comprising six fruit pieces. Thus, each treatment was applied to 24 fruit pieces. The fruit treated in this example were six freshly harvested, mature Navel oranges. All treatments were conducted at 20° C. unless indicated differently.

Treatments were as follows:

A. Fruit immersed in water. Untreated uninoculated control.

B. Fruit immersed in water. Untreated inoculated control.

C. Fruit immersed in a solution containing a 200 ppm suspension of Imazalil for 2 minutes.

D. Fruit immersed in a solution containing 2% (w/w) potassium phosphite for 2 minutes.

E. Fruit immersed in a solution containing a mixture of 1 a 200 ppm suspension of Imazalil and 2% (w/w) potassium phosphite, for 2 minutes.

F. Fruit immersed in a solution containing a mixture of a 200 ppm suspension of Imazalil and 2% (w/w) potassium phosphite, for 2 minutes at 40° C.

After the treatments were applied and left to dry for 10 minutes, treatments B through F were inoculated with a mixed inocula of Green mold (P. digitatum) and Blue mold (P. italicum). Fruit inoculation was performed by piercing the fruit skin to a depth of 3-5 mm with a needle coated with spores from both fungi. Fruit was incubated at approximately 25° C. and decay development measured over 7 days from inoculation.

This experiment was repeated twice.

Results of Example 3:

TABLE 3
(Mean of two experiments)

| | Lesion diameter | % change from |
|---|---|---|
| Treatment | (mm) day 7 | inoculated control |
| A | 0 | — |
| B | 51 | — |
| C | 39 | −83 |
| D | 28 | −74 |
| E | 15 | −86 |
| F | 10 | −79 |

### EXAMPLE 4

In example 4, six different treatments (A-F below) were made. There were four replications for each of the six treatments, with each replicate comprising six fruit pieces. Thus, each treatment was applied to 24 fruit pieces. The fruit treated in this example were six freshly harvested, mature Navel oranges. All treatments were conducted at 20° C. unless indicated differently.

Treatments were as follows:

A. Fruit immersed in water. Untreated uninoculated control.

B. Fruit immersed in water. Untreated inoculated control.

C. Fruit immersed in a solution containing a 200 ppm suspension of Imazalil for 2 minutes.

D. Fruit immersed in a solution containing 2% (w/w) potassium phosphite for 2 minutes.

E. Fruit immersed in a solution containing a mixture of 1 a 200 ppm suspension of Imazalil and 2% (w/w) potassium phosphite, for 2 minutes.

F. Fruit immersed in a solution containing a mixture of a 200 ppm suspension of Imazalil and 2% (w/w) potassium phosphite, for 2 minutes at 40° C.

After the treatments were applied and left to dry for 10 minutes, treatments B through F were inoculated with a mixed inocula of Green mold (P. digitatum) and Blue mold (P. italicum). Fruit inoculation was performed by piercing the fruit skin to a depth of 3-5 mm with a needle coated with spores from both fungi. Fruit was incubated at approximately 25° C. and decay development measured over 7 days from inoculation.

This experiment was repeated twice.

Results of Example 4:

TABLE 4
(Mean of two experiments)

| | Lesion diameter | % change from |
|---|---|---|
| Treatment | (mm) day 7 | inoculated control |
| A | 0 | — |
| B | 68 | — |
| C | 43 | −45 |
| D | 40 | −89 |
| E | 12 | −94 |
| F | 6 | −91 |

It is to be appreciated that although an exemplary solution of 2% w/w potassium phosphite was used in the exemplary experiments herein, numerous other salts of phosphorous acid may also be effectively used. It is also to be appreciated that any suitable phosphorous acid source may be effectively used in a range of between about 0.1% and about 10% w/w phosphorous acid equivalent, preferably in a range of between about 1% and about 3% w/w phosphorous acid equivalent. Similarly, the Imazalil source may be effectively used in a range of between about 10 mg/L and about 10,000 mg/L. Different combinations of these source materials over these ranges are contemplated within the scope of the present invention.

Solid forms of the invention may be obtained, for example, by evaporating any of the solutions identified in the examples.

It is to be appreciated that, although the invention has been described in terms of exemplary embodiments, it is not limited thereto. Rather, the appended claims should be construed so as to include other variants and embodiments of the invention which may be made by those skilled in the art without departing from the scope and range of equivalents of the invention.

What is claimed is:

1. A method for protecting one of a fruit, a vegetable or an ornamental against post harvest microbial spoilage by applying thereto a mixture comprising an Imazalil source and a phosphorous acid source selected from the group of phosphorous acid, an alkali metal salt of phosphorous acid, and combinations thereof.

2. The method of claim 1 wherein said mixture comprises an aqueous solution wherein said Imazalil source is present in a range of between about 10 mg/L and about 10,000 mg/L, and wherein said phosphorous acid source is present in a range of between about 0.1% and about 10% w/w phosphorous acid equivalent.

3. The method of claim 1 wherein said Imazalil source is present in an amount of about 200 ppm, and wherein said phosphorous acid source is present in a range of between about 1% and about 3% w/w phosphorous acid equivalent.

4. The method of claim 1 wherein said Imazalil source is present in an amount of about 200 ppm, and wherein said phosphorous acid source is present in an amount of about 2% w/w phosphorous acid equivalent.

5. The method of claim 1 comprising the additional step of at least partially immersing said fruit, vegetable or ornamental in said solution for a time interval between about 5 seconds and about 10 minutes.

6. The method of claim 2 comprising the additional step of at least partially immersing said fruit, vegetable or ornamental in said solution for a time interval between about 5 seconds and about 10 minutes.

7. The method of claim 1 comprising the additional step of at least partially immersing said fruit, vegetable or ornamental in said solution for a time interval between about 1 minute and about 3 minutes.

8. The method of claim 2 comprising the additional step of at least partially immersing said fruit, vegetable or ornamental in said solution for a time interval between about 1 minute and about 3 minutes.

9. The method of claim 2 wherein the fruit, vegetable or ornamental is drenched with the solution.

10. The method of claim 3 wherein the fruit, vegetable or ornamental is drenched with the solution.

11. The method of claim 2 wherein the fruit, vegetable or ornamental is sprayed with the solution.

12. The method of claim 3 wherein the fruit, vegetable or ornamental is sprayed with the solution.

13. A method of protecting one of a fruit, a vegetables or an ornamental against post harvest microbial spoilage comprising the steps of:
preparing a composition comprising an Imazalil source wherein said Imazalil source is present in a range of between about 10 mg/L and about 30,000 mg/L; and a phosphorous acid source selected from the group of phosphorous acid, an alkali metal salt of phosphorous acid, and combinations thereof, wherein said phosphorous acid source is present in a range of between about 0.1% and about 10% w/w phosphorous acid equivalent;
incorporating the composition into a wax coating; and
applying said coating to said fruit, vegetable or ornamental.

14. The method of claim 13 wherein said phosphorous acid source is present in a range of between about 2% and about 3% w/w phosphorous acid equivalent.

15. The method of claim 13 wherein said Imazalil source is present in an amount of about 200 ppm, and wherein said phosphorous acid source is present in a range of between about 1% and about 3% w/w phosphorous acid equivalent.

16. The method of claim 13 wherein said Imazalil source is present in an amount of about 200 ppm, and wherein said phosphorous acid source is present in an amount of about 2% w/w phosphorous acid equivalent.

17. The method of claim 2 wherein said mixture further comprises a fungicide.

18. The method of claim 13 wherein said mixture further comprises a fungicide.

19. The method of claim 2 wherein said mixture further comprises a biocide.

20. The method of claim 13 wherein said mixture further comprises a biocide.

21. The method of claim 2 wherein said mixture is provided in one of a solid state and a liquid state.

22. The method of claim 13 wherein said mixture is provided in one of a solid state and a liquid state.

23. The method of claim 2 wherein said mixture is heated to a temperature of between about 30° and about 50° C. to increase decay control efficacy.

24. The method of claim 13 wherein said mixture is heated to a temperature of between about 30° and about 50° C. to increase decay control efficacy.
